(19) United States
(12) Patent Application Publication
(10) Pub. No.: US 2023/0236046 A1
(43) Pub. Date: Jul. 27, 2023

(54) Calibration of Sine-Cosine Coil Mismatches in Inductive Sensors

(71) Applicant: Microchip Technology Incorporated, Chandler, AZ (US)

(72) Inventor: Ajay Kumar, Phoenix, AZ (US)

(73) Assignee: Microchip Technology Incorporated, Chandler, AZ (US)

(21) Appl. No.: 18/095,743

(22) Filed: Jan. 11, 2023

Related U.S. Application Data
(60) Provisional application No. 63/303,843, filed on Jan. 27, 2022.

(51) Int. Cl. G01D 18/00; G01D 5/20; G01B 7/00

(52) U.S. Cl. CPC G01D 18/00; G01B 7/003; G01D 5/2053

(57) ABSTRACT

An apparatus includes a sampling circuit to sample input from a sensor circuit. The input includes a cosine coil waveform and a sine coil waveform. The sampling circuit is to generate a cosine coil sampled data stream and a sine coil sampled data stream. The apparatus includes an adjustment circuit to, based upon a characterization of the sensor circuit, delay the cosine coil sampled data stream or the sine coil sampled data stream.

### PRIORITY

The present application claims priority to U.S. Provisional Pat. Application No. 63/303,843, filed Jan. 27, 2022, the contents of which are hereby incorporated in their entirety.

### FIELD OF THE INVENTION

The present application relates to inductive sensing and, more particularly, to calibration of a sine-cosine coil mismatch of an inductive sensor.

### BACKGROUND

Inductive sensors may measure a position or orientation of a foreign object, such as a rotor, stator, finger, stylus, or other body. Inductive sensors may utilize an excitation coil, a first sense coil (which may be called a sine coil), and a second sense coil (which may be called a cosine coil). The excitation coil may be part of an inductor-capacitor (LC) circuit or a resistor-inductor-capacitor (RLC) circuit, coupled to an oscillator circuit. These circuits may generate sinusoidal signals associated with their tank frequency for detections, or measurements. The body may be provided which may disturb the magnetic coupling between the excitation coil and the first and second sense coils. Changes in the magnetic coupling to the first and second sense coils can be used to detect the position of the target, in terms of, for example, linear or angular motion..

Inductive positioning sensor may be implemented in part by components soldered onto printed circuit boards (PCBs). As such, the capacitors of the inductive positioning sensor system may be soldered onto the PCBs. The first and second sense coils may be disposed on a PCB. Ideally, the first and second sense coils are matched, so that the output of the first and second sense coils reflect their positions, and as a result the position of the target can be calculated. In one example, the first and second sense coils are precisely ¼ of a wavelength apart, where the wavelength refers to the wavelength of the oscillating signal produced by the oscillator and the excitation coil circuit. In one example, the angle of the target whose angular position is to be determined may be termed θ. The first sense coil, i.e., the sine coil, may produce a signal based on sin (0), and the second sense coil may produce a signal based on cos (θ). The position sensor may determine the angular position based on tan⁻¹ (sin(θ)/cos(θ)). Inventors of examples of the present disclosure have discovered that any error in the relationship, may be considered to change the result to tan⁻¹ (sin(θ)/cos(θ)+ ε), where ε represent the error. A constant error ε, results in a large angle error near 0 degrees and a small angle error near 90 degrees.

Inventors of examples of the present disclosure have discovered that the sine and cosine coils may not be precisely matched in production, due to manufacturing rounding of lengths, which leads to error in the resulting position calculation, e.g., by arctangent. Such a mismatch may produce disproportionately larger errors. In production, such surface-mount capacitors are often themselves insufficiently accurate. Moreover, changing the frequency of the resultant LC and RLC circuits of the inductive positioning sensors may include de-soldering and removing one surface-mount capacitor and replacing it with another surface-mount capacitor that is to be soldered again to the PCB. These approaches have been found to be time-consuming, imprecise, and not very cost effective. In addition, inductors with high tolerances have been found to be very expensive to form on PCBs. Examples of the present disclosure may address one or more of these discoveries by the inventors.

### BRIEF DESCRIPTION OF THE DRAWINGS

FIG. 1 is an illustration of an example system 100 for inductive position sensing, according to examples of the present disclosure.

FIG. 2 is an illustration of another example system 200 for inductive position sensing, according to examples of the present disclosure.

FIG. 3 is a more detailed illustration of sensor circuit 202 or sensor circuit 102, according to examples of the present disclosure.

FIG. 4 is an illustration of misalignment.

FIG. 5 is an illustration of an example method 500, according to examples of the present disclosure.

### DETAILED DESCRIPTION

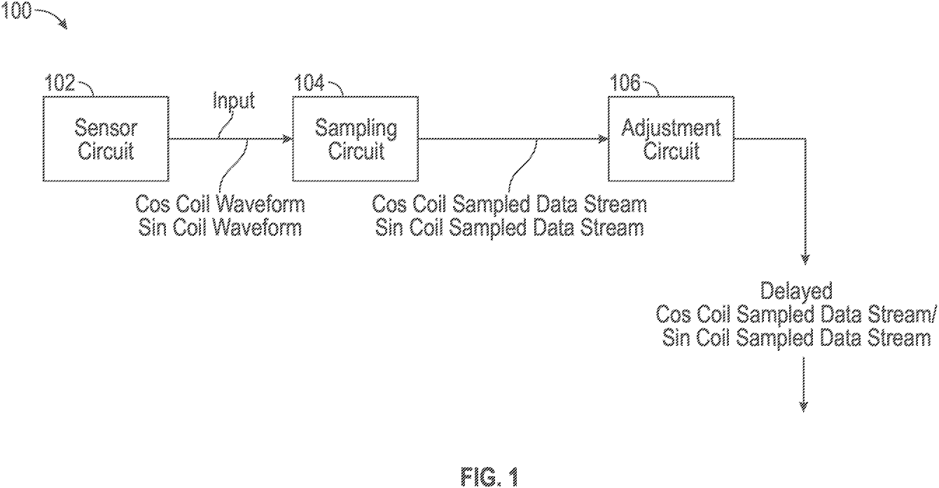

FIG. 1 is an illustration of an example system 100 for inductive position sensing, according to examples of the present disclosure. System 100 may include a sensor circuit 102, a sampling circuit 104, and an adjustment circuit 106.

Sensor circuit 102 may be implemented in any suitable manner, including with an inductive circuit to detect position of a linear moving target or a rotating target. Sensor circuit 102 may include an oscillator and one or more excitation coils to produce an oscillating signal. Sensor circuit 102 may include a first sense coil, i.e., a sine coil, and a second sense coil, i.e., a cosine coil. In the presence of a target, the amount of coupling between the excitation coil and the sine and cosine coils may be disturbed. The amount of disturbance may be determined and utilized to detect a position of the target. The sense coils may be arranged as a sine coil and a cosine coil. Sensor circuit 102 may be implemented in, for example, on a PCB where the sine coil and the cosine coil represent respective traces. Sensor circuit 102 may include a capacitor.

Sampling circuit 104 and adjustment circuit 106 may be implemented in any suitable manner, such as analog circuitry, digital circuitry, instructions for execution by a processor, an application specific integrated circuit (ASIC), a field programmable gate array (FPGA), reconfigurable or programmable logic, or any suitable combination thereof.

Sampling circuit 104 may be configured to sample input from sensor circuit 102. The input may include a cosine coil waveform and a sine coil waveform. From these waveforms, sampling circuit 104 may be configured to generate a cosine coil sampled data stream and a sine coil sampled data stream, respectively. Sampling circuit 104 may be configured to provide the cosine coil sampled data stream and the sine coil sampled data stream to adjustment circuit 106.

A characterization of sensor circuit 102 may first be determined. This may be determined as part of a calibration process at a factory, by measuring the length of the respective and cosine coils of sensor circuit 102, to determine an amount of mismatch. The characterization may be based upon a relative length difference between the cosine coil and the sine coil of sensor circuit 102, and may be detected during a characterization phase, which may be performed in a factory setting. Adjustment circuit 106 may be configured to, responsive to the relative length difference between the cosine coil and the sine coil of sensor circuit 102, to add a delay to one of the sine coil sampled data stream or the cosine coil sampled data stream to compensate for the relative length difference. The delay may be corrected for a length error or a starting location error in the cosine coil or sine coil with respect to the other coil. The characterization may be stored in, for example, memory, a register, or any other suitable part of adjustment circuit 106 or system 100, and may represent a whole number offset for sample adjustments.

Adjustment circuit 106 may be configured to, based upon the characterization of sensor circuit 102, delay one of the cosine coil sampled data stream or the sine coil sampled data stream. Adjustment circuit 106 may be configured to provide a delayed cosine coil sampled data stream and the sine coil sampled data stream, or the cosine coil sampled data stream and a delayed sine coil sampled data stream to any suitable entity such as the LX3302A available from Microchip Technology, Inc., of Chandler, Arizona, which is an integrated programmable data conversion integrated circuit for interfacing to and managing of inductive position sensors. Such an entity may include, for example, a digital signal processing unit.

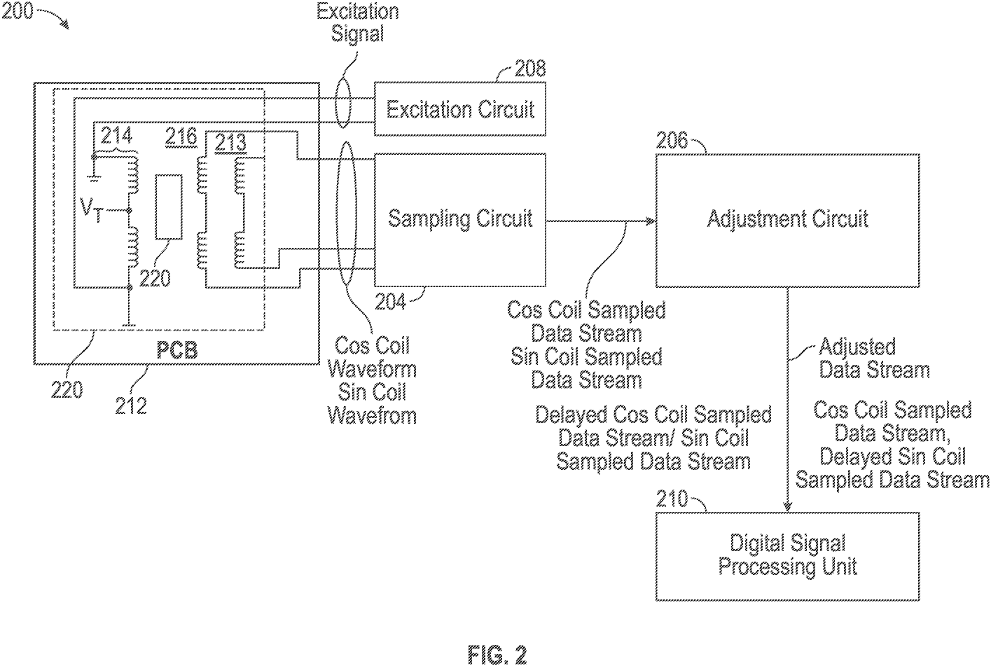

FIG. 2 is an illustration of another example system 200 for inductive position sensing, according to examples of the present disclosure. System 200 may be a more detailed view of system 100.

System 200 may include a sensor circuit 202, a sampling circuit 204, and an adjustment circuit 206. Sensor circuit 202 may be implemented by sensor circuit 102, and vice-versa. Sampling circuit 204 may be implemented by sampling circuit 104, and vice-versa. Adjustment circuit 206 may be implemented by adjustment circuit 106, and vice-versa.

System 200 may include an excitation circuit 208. Excitation circuit 208 may be implemented in any suitable manner, such as analog circuitry, digital circuitry, instructions for execution by a processor, FPGA, ASIC, reconfigurable logic, or any suitable combination thereof to provide an oscillation signal to the excitation coil of sensor circuit 202.

System 200 may include a processing circuit 210. Processing circuit 210 may be implemented in any suitable manner, such as analog circuitry, digital circuitry, instructions for execution by a processor, a processor, an ASIC, an FPGA, reconfigurable logic, a digital signal processor, or any suitable combination thereof.

System 200 may include a PCB 212, upon which an excitation coil 214, a sine coil 216 and a cosine coil 218 of system 100 may be placed.. Sensor circuit 202 may include a primary coil 214.

Excitation circuit 208 may be configured to produce an excitation signal. The excitation signal may be provided to either end of excitation coil 214, or to both ends. The middle of primary coil 214 may be connected to a power supply, such as VT of system 200. A first end of sine coil 216 and cosine coil 218 may be connected to ground. The excitation signal may cause excitation coil 214 to oscillate which may cause an effect in sine and cosine coils 216, 218 based upon a presence, position, or other aspect of external phenomena, such as a target 220.

Sampling circuit 204 may be configured to sample input from sensor circuit 202. The input may include a sine coil waveform and a cosine coil waveform output respectively by sine coil 216 and cosine coil 218. Sampling circuit 202 may be connected to a second end of sine coil 216, and to a second end of cosine coil 218.

From these waveforms, sampling circuit 204 may be configured to generate a sine coil sampled data stream and a cosine coil sampled data stream, respectively. Sampling circuit 204 may be configured to provide the sine coil sampled data stream and the cosine coil sampled data stream to adjustment circuit 206.

Adjustment circuit 206 may be a characterization of sensor circuit 202. The characterization may be based upon a relative length difference between the sine coil 216 and the cosine coil 218 of sensor circuit 202. The characterization may be stored in, for example, memory, a register, or any other suitable part of system 200, accessible by adjustment circuit 206. The characterization may be implemented in any suitable manner, such as a whole number offset for sample adjustments.

Adjustment circuit 206 may provide an adjusted data stream. The adjusted data stream may be generated through delay one of the sine coil sampled data stream or the cosine coil sampled data stream. Adjustment circuit 206 may be configured to provide the adjusted data stream to any suitable entity. A delayed cosine coil sampled data stream and the sine coil sampled data stream, or the cosine coil sampled data stream and a delayed sine coil sampled data stream, may be provided to any suitable entity. Such an entity may include, for example, processing circuit 210.

Processing circuit 210 may be configured to utilize the adjusted data stream in any suitable manner, such as evaluating the external phenomena detected by sensor circuit 202 to determine a position of body 220.

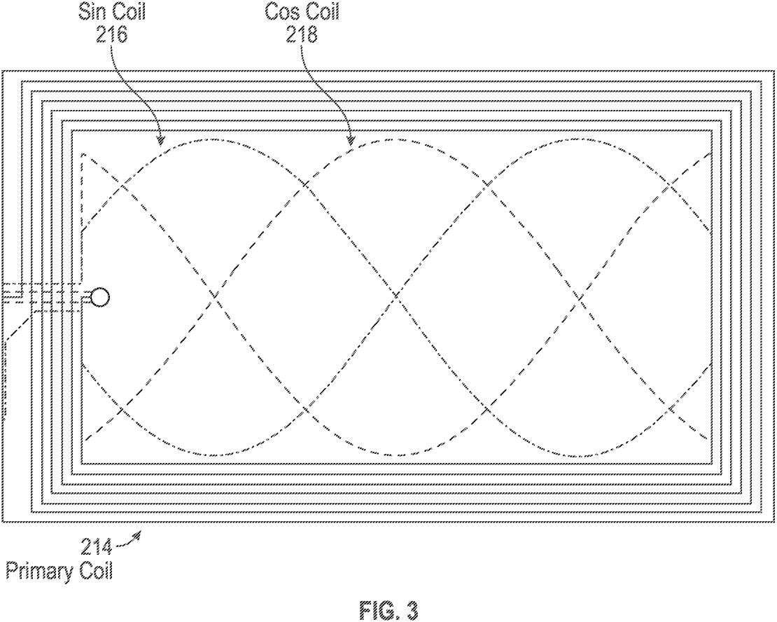

FIG. 3 is a more detailed illustration of sensor circuit 202 or sensor circuit 102, according to examples of the present disclosure. FIG. 3 may illustrate sensor circuit 202 or sensor circuit 102 as it is laid out on a PCB, such as PCB 212. FIG. 3 may illustrate sensor circuit 202 or sensor circuit 102 from a top-down perspective. Traces may form excitation coil 214, sine coil 216, and cosine coil 218.

Returning to FIG. 2, sine coil 216 and cosine coil 218 may provide two different oscillation outputs that are input to sampling circuit 204. A position of body 220 may be mapped across a possible range over sensor circuit 202. The possible range may be, for example, a length or width across sensor circuit 202, or an angular position. The range may be mapped or normalized by, for example, mapping possible positions across sensor circuit 202 in degrees. For example, a range across sensor circuit 202 may be mapped into 360 segments, each corresponding to a degree. Those of skill in the art may understand that such mappings in degrees may also be performed in equivalent radian measurements. The present disclosure may provide examples as expressed in degrees.

Sine coil 216 and cosine coil 218 may respectively provide a measurement that corresponds to a position, wherein the position is expressed in degrees. Thus, when body 220 is in a given position, such as X°, sine coil 216 may provide a given measurement value (given as sin(θ=X°)), and cosine coil 218 may provide a given measurement value (given as cos(θ=X°)). The output of the total, digital converted output from sine coil 216 and cosine coil 218 may be a ratio of the inputs from coils 216, 218 and may be given as K. The ratio of two digital converted output (K) gives tan (θ) = sine(θ)/cosine(θ), and the final output from the device may be arctan(K) = θ.

The physical traces that comprise respectively sine coil 216 and cosine coil 218 may have various imperfections due to, for example, manufacturing defects, variations, and rounding of length leads. The physical traces that comprise respectively sine coil 216 and cosine coil 218 may be designed to have a phase difference with tolerances of up to ¼ of a wavelength of the excitation signal provided by excitation coil 214. A phase error may arise due to manufacturing tolerances. A measurement from cosine coil 218 for a given ideal position X° may correspond to a measurement from sine coil 216 for the given ideal position X° plus an error. Similarly, a measurement from sine coil 216 for a given ideal position X° may correspond to a measurement from cosine coil 218 for the given ideal position X° plus an error.

Tangent (θ) varies between zero and infinity. An error, given as e, may result from the measurements of sine coil 216 and cosine coil 218 as a large angle error when θ is near zero degrees, but a very small error when the same quantity of error occurs when θ is near 90 degrees. Thus, the error might not only reduce the accuracy of the measurement, the error may be very non-linear, making it difficult to correct numerically after measurement.

Adjustment circuit 206 may be configured to delay respectively sampled data so that sampled data generated from sampling circuit 204 from sine coil 216 and cosine coil 218 are better or more closely aligned so as to prevent or correct phase error. During characterization, it may be determined whether one of coils 216, 218 is leading the other in phase. Whether one coil is leading the other in phase may be determined after production or manufacturing, during a test or validation phase. Information sufficient for adjustment circuit 206 to adjust a delay of samples of one of the secondary coils 216, 218 in relation to samples of the other of the secondary coils 216, 218 may be stored in any suitable manner, such as in a register, fuses, read-only memory, persistent memory, or in any other suitable manner accessible by adjustment circuit 206. Adjustment circuit 206 may read such information, and then apply such information to sampled values from sine coil 216 or cosine coil 218.

Adjustment circuit 206 may add a delay to one of the sine or cosine sampled values to at least partially correct for positive or negative manufacturing length error. The sampling rate of circuitry for the inductive sensor may, in one non-limiting example, range from 1 KHz to 20 KHz. Assuming that there is a 360-sample point mapping of positions for sensor circuit 202, 360 points-one for each degree-may be represented on each of the secondary coils 216, 218. For example, considering the following ideal sampling that produced cosine and sine coil sampled data streams, wherein there is no misalignment between the sine and cosine coils:

Ideal sampling

| | | | | | | | | | | |
|---|---|---|---|---|---|---|---|---|---|---|
| Sine coil 216 | - 180° | - 179° | ... | -2° | -1° | 0° | 1° | ... | 179° | 180° |
| Cosine Coil 218 | -90° | -89° | ... | 88° | 89° | 90° | 91° | ... | 269° | 270° |
| Index | | | | | n-1 | n | n+1 | | | |

In this ideal scenario, there is no misalignment, and the measurements at a given time of sine coil 216 is 90° apart from cosine coil 218.

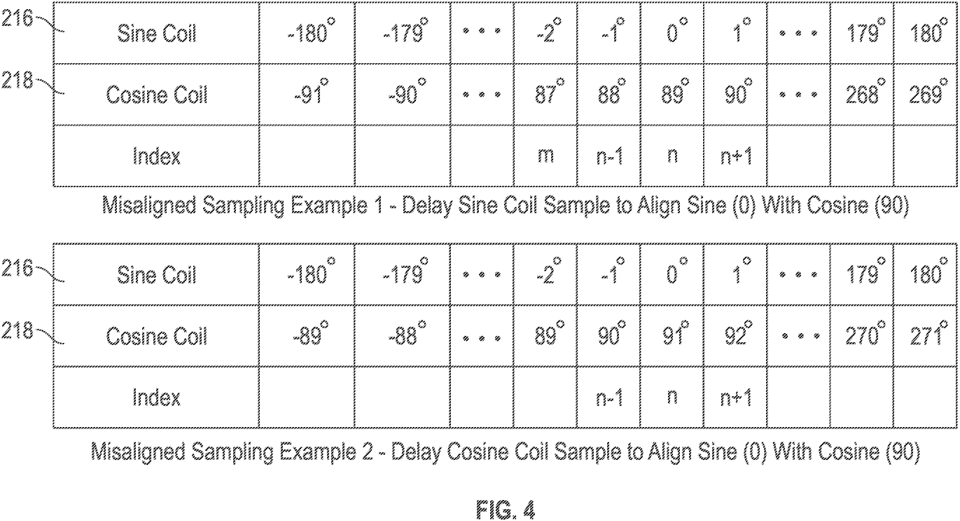

In contrast, in a real scenario, there may be a misalignment as shown in FIG. 4.

In the misaligned sampling example 1 shown in FIG. 4, adjustment circuit 206 may be configured to add a delay to the sampled data of sine coil 216, such that measurements of sine coil 216 at 0° align with measurements of cosine coil 218 at 90°, rather than aligning with measurements of cosine coil at 89°. In other examples, wherein the misalignment is of a greater value, adjustment circuit 206 may be configured to add a greater delay so that the measurements align. The delay may be performed by offsetting the sample vector of sine coil 216 by one or more measurements.

In the misaligned sampling example 2 shown in FIG. 4, adjustment circuit 206 may be configured to add a delay to the sampled data of cosine coil 218, such that measurements of cosine coil 216 at 90° now align with measurements of sine coil 216 at 0°, rather than aligning with measurements of sine coil at -1°. In other examples, wherein the misalignment is of a greater value, adjustment circuit 206 may be configured to add a greater delay so that the measurements align. The delay may be performed by offsetting the sample vector of cosine coil 218 by one or more measurements.

Thus, delaying a sampled data stream from cosine coil 218 may match a sample indexed as n+1 of a sampled data stream from sine coil 216 with a sample indexed as n of the sampled data stream from cosine coil 218. Conversely, delaying a sampled data stream from sine coil 216 may match a sample indexed as n+1 of a sampled data stream from cosine coil 218 with a sample indexed as n of the sampled data stream from sine coil 216.

More broadly, delaying a sampled data stream from cosine coil 218 may match a sample indexed as n of a sampled data stream from sine coil 216 with a sample indexed as m of the sampled data stream from cosine coil 218, wherein n is greater than m. Conversely, delaying a sampled data stream from sine coil 216 may match a sample indexed as n of a sampled data stream from cosine coil 218 with a sample indexed as m of the sampled data stream from sine coil 216, wherein n is greater than m.

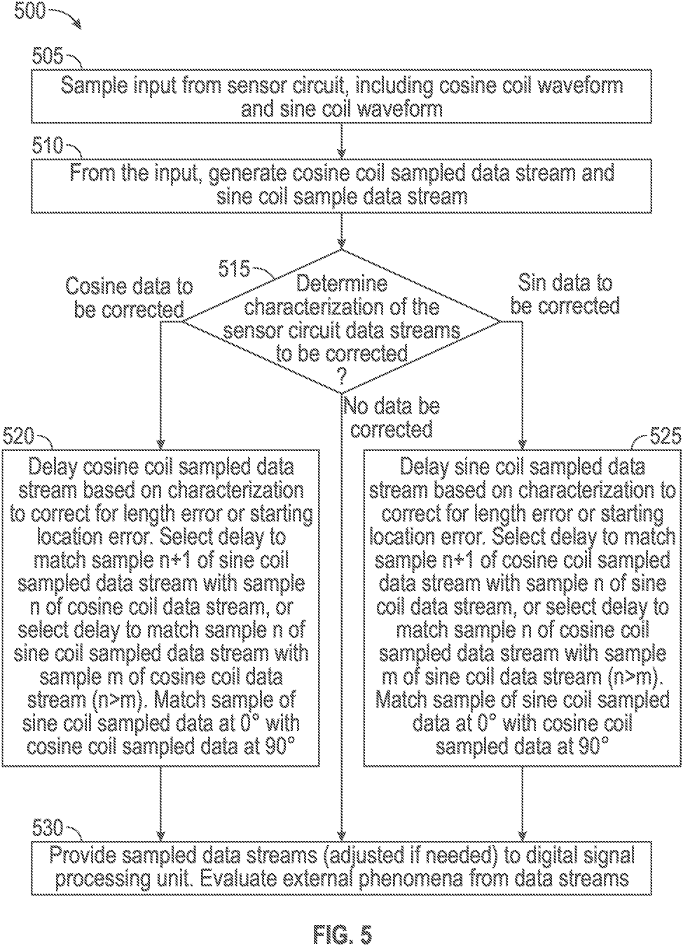

FIG. 5 is an illustration of an example method 500, according to examples of the present disclosure. Method 500 may be performed by any suitable entity, such as system 100 or system 200. Method 500 may include more or fewer steps than shown in FIG. 5. The steps of method 500 may be performed in any suitable manner or order. Steps of method 500 may be optionally repeated, omitted, performed recursively, or performed in parallel.

At 505, input may be sampled from a sensor circuit. The sensor input may include cosine coil waveforms and sine coil waveforms.

At 510, from the input at 505, cosine coil sampled data streams and sine coil sampled data streams may be generated.

At 515, a characterization of the sensor circuit may be determined. The characterization may define whether the sine coil or the cosine coil have an error of any kind. The characterization may define how such an error may be corrected for or accounted for. If a cosine coil sampled data stream is to be corrected, method 500 may proceed to 520. If a sine coil sampled data stream is to be corrected, method 500 may proceed to 525. If neither are to be corrected, method 500 may proceed to 530. 515 may be performed at a characterization stage at the factory prior to shipment.

At 520, if the cosine data is to be delayed, the cosine coil sampled data stream may be delayed based upon characterization of 515 to correct for length error or starting location error. The delay may be selected to match a sample n+1 of the sine coil sampled data stream with a sample n of the cosine coil data stream, or selected to match a sample n of the sine coil sampled data stream with a sample m of the cosine coil data stream (wherein n>m). A sample of the sine coil sampled data at 0° may thus be matched with the cosine coil sampled data at 90°.

At 525, if the sine data is to be delayed, the sine coil sampled data stream may be delayed based on characterization to correct for length error or starting location error. The delay may be selected to match a sample n+1 of the cosine coil sampled data stream with a sample n of the sine coil data stream, or selected to match a sample n of the cosine coil sampled data stream with a sample m of the sine coil data stream (wherein n>m). A sample of the sine coil sampled data at 0° may be matched with the cosine coil sampled data at 90°.

At 530, the sampled data streams (which may have been adjusted) may be provided to a processing circuit, which may evaluate the data to determine external phenomena.

Examples of the present disclosure an apparatus. The apparatus may include a sampling circuit configured to sample input from a sensor circuit. The input may include a cosine coil waveform and a sine coil waveform. The sampling circuit may be configured to generate a cosine coil sampled data stream and a sine coil sampled data stream. The apparatus may include an adjustment circuit to, based upon a characterization of the sensor circuit, delay the cosine coil sampled data stream or the sine coil sampled data stream.

In combination with any of the above examples, the adjustment circuit may be configured to delay the cosine coil sampled data stream. The delay may match a sample (n+1) of the sine coil sampled data stream with a sample n of the cosine coil sampled data stream.

In combination with any of the above examples, wherein the adjustment circuit may be configured to delay the sine coil sampled data stream. The delay to match a sample (n+1) of the cosine coil sampled data stream with a sample n of the sine coil sampled data stream.

In combination with any of the above examples, the adjustment circuit may be configured to delay the sine coil sampled data stream. The delay may match a sample n of the sine coil sampled data stream with a sample m of the cosine coil sampled data stream, wherein n is greater than m.

In combination with any of the above examples, the adjustment circuit may be configured to delay the cosine coil sampled data stream. The delay may match a sample n of the cosine coil sampled data stream with a sample m of the sine coil sampled data stream, wherein n is greater than m.

In combination with any of the above examples, the adjustment circuit may be configured to delay the cosine coil sampled data stream or the sine coil sampled data stream based upon the characterization of the sensor circuit so as to correct for a length error or starting location error in the sine coil or the cosine coil.

In combination with any of the above examples, the cosine coil waveform and the sine coil waveform may be normalized to a degree mapping. The adjustment circuit may be to delay the cosine coil sampled data stream or delay the sine coil sampled data to match a sample of the sine coil sampled data at 0 degrees with a sample of the cosine coil sampled data at 90 degrees.

Examples of the present disclosure may include a system. The system may include a PCB. The PCB may include a sensor circuit. The sensor circuit may include an excitation coil, a sine coil and a cosine coil. The cosine coil and the sine coil may be configured to provide a response of the sensor circuit to an external body. The system may include an excitation circuit to provide an excitation signal to the sensor circuit to cause the response of the sensor circuit to the external body. The system may include any of the sampling circuits and adjustment circuits of any of the above apparatuses. The sampling circuit may be configured to sample a cosine coil waveform and a sine coil waveform from the PCB to generate a cosine coil sampled data stream and to sample the sine coil waveform to generate a sine coil sampled data stream. The adjustment circuit may be configured to, based upon a characterization of the sensor circuit, delay the cosine coil sampled data stream or the sine coil sampled data stream to yield an adjusted data stream. The system may include a processing circuit configured to evaluate external phenomena based upon the adjusted data stream.

The sensor circuit, sampling circuit, excitation circuit, adjustment circuit, and processing circuit may each be implemented in any suitable manner, such as analog circuitry, digital circuitry, instructions for execution by a processor, a processor, an ASIC, an FPGA, reconfigurable logic, a digital signal processor, or any suitable combination thereof

Although examples have been described above, other variations and examples may be made from this disclosure without departing from the spirit and scope of these examples.

We claim:

1. An apparatus, comprising:
a sampling circuit to sample input from a sensor circuit, the input including a cosine coil waveform and a sine coil waveform, the sampling circuit to generate a cosine coil sampled data stream and a sine coil sampled data stream; and
an adjustment circuit to, based upon a characterization of the sensor circuit, delay the cosine coil sampled data stream or the sine coil sampled data stream.

2. The apparatus of claim 1, wherein the adjustment circuit is to delay the cosine coil sampled data stream, the delay to match a sample (n+1) of the sine coil sampled data stream with a sample n of the cosine coil sampled data stream.

3. The apparatus of claim 1, wherein the adjustment circuit is to delay the sine coil sampled data stream, the delay to match a sample (n+1) of the cosine coil sampled data stream with a sample n of the sine coil sampled data stream.

4. The apparatus of claim 1, wherein the adjustment circuit is to delay the sine coil sampled data stream, the delay to match a sample n of the sine coil sampled data stream with a sample m of the cosine coil sampled data stream, wherein n is greater than m.

5. The apparatus of claim 1, wherein the adjustment circuit is to delay the cosine coil sampled data stream, the delay to match a sample n of the cosine coil sampled data stream with a sample m of the sine coil sampled data stream, wherein n is greater than m.

6. The apparatus of claim 1, wherein the adjustment circuit is to delay the cosine coil sampled data stream or the sine coil sampled data stream based upon the characterization of the sensor circuit so as to correct for a length error or starting location error in the sine coil or the cosine coil.

7. The apparatus of claim 1, wherein: the cosine coil waveform and the sine coil waveform are normalized to a degree mapping; and
the adjustment circuit is to delay the cosine coil sampled data stream or delay the sine coil sampled data to match a sample of the sine coil sampled data at 0 degrees with a sample of the cosine coil sampled data at 90 degrees.

8. A method, comprising:
sampling input from a sensor circuit, the input including a cosine coil waveform and a sine coil waveform, thereby generating a cosine coil sampled data stream and a sine coil sampled data stream, respectively; and
based upon a characterization of the sensor circuit, delaying the cosine coil sampled data stream or the sine coil sampled data stream.

9. The method of claim 8, comprising delaying the cosine coil sampled data stream, the delay to match a sample n of the sine coil sampled data stream with a sample (n+1) of the cosine coil sampled data stream.

10. The method of claim 8, comprising delaying the sine coil sampled data stream, the delay to match a sample (n+1) of the sine coil sampled data stream with a sample n of the cosine coil sampled data stream.

11. The method of claim 8, comprising delaying the sine coil sampled data stream to match a sample n of the sine coil sampled data stream with a sample m of the cosine coil sampled data stream, wherein n is greater than m.

12. The method of claim 8, comprising delaying the cosine coil sampled data stream the delay to match a sample n of the cosine coil sampled data stream with a sample m of the sine coil sampled data stream, wherein n is greater than m.

13. The method of claim 8, comprising delaying the cosine coil sampled data stream or the sine coil sampled data stream based upon the characterization of the sensor circuit so as to correct for a length error or starting location error in the sine coil or the cosine coil.

14. The method of claim 8, comprising:
normalizing the sampling of the cosine coil waveform and the sampling of the sine coil waveform to a degree mapping; and
delaying the cosine coil sampled data stream or delaying the sine coil sampled data so as to match a sample of the sine coil waveform sampled data at 0 degrees with a sample of the cosine coil waveform sampled data at 90 degrees.

15. A system, comprising:
a printed circuit board (PCB), the PCB including a sensor circuit, the sensor circuit to include an excitation coil, a sine coil and a cosine coil, the cosine coil and the sine coil to provide a response of the sensor circuit to an external body;
an excitation circuit to provide an excitation signal to the sensor circuit to cause the response of the sensor circuit to the external body;
a sampling circuit to sample a cosine coil waveform and a sine coil waveform from the PCB to generate a cosine coil sampled data stream and to sample the sine coil waveform to generate a sine coil sampled data stream;
an adjustment circuit to, based upon a characterization of the sensor circuit, delay the cosine coil sampled data stream or the sine coil sampled data stream to yield an adjusted data stream; and
a processing circuit to evaluate external phenomena based upon the adjusted data stream.

16. The system of claim 15, wherein the adjustment circuit is to delay the cosine coil sampled data stream, the delay to match a sample n of the sine coil sampled data stream with a sample (n+1) of the cosine coil sampled data stream.

17. The system of claim 15, wherein the adjustment circuit is to delay the sine coil sampled data stream, the delay to match a sample (n+1) of the sine coil sampled data stream with a sample n of the cosine coil sampled data stream.

18. The system of claim 15, wherein the adjustment circuit is to delay the sine coil sampled data stream, the delay to match a sample n of the sine coil sampled data stream with a sample m of the cosine coil sampled data stream, wherein n is greater than m.

19. The system of claim 15, wherein the adjustment circuit is to delay the cosine coil sampled data stream, the delay to match a sample n of the cosine coil sampled data stream with a sample m of the sine coil sampled data stream, wherein n is greater than m.

20. The system of claim 15, wherein the adjustment circuit is to delay the cosine coil sampled data stream or the sine coil sampled data stream based upon the characterization of the sensor circuit so as to correct for a length error or starting location error in the sine coil or the cosine coil.

21. The system of claim 15, wherein:
the sampling of the cosine coil waveform and the sampling of the sine coil waveform are normalized to a degree mapping; and
the adjustment circuit is to delay the cosine coil sampled data stream or delay the sine coil sampled data to match a sample of the sine coil sampled data at 0 degrees with a sample of the cosine coil sampled data at 90 degrees.
